(19) United States
(12) Patent Application Publication
(10) Pub. No.: US 2021/0365613 A1
(43) Pub. Date: Nov. 25, 2021

(54) SYSTEM AND METHOD FOR DETECTING EXCESSIVE VIBRATION IN A CONSUMER DEVICE USING COMPUTERIZED MODELING

(71) Applicant: GOOGLE LLC, Mountain View, CA (US)

(72) Inventors: Neha Dixit, Mountain View, CA (US); Liang Cheng, Mountain View, CA (US)

(21) Appl. No.: 16/880,750

(22) Filed: May 21, 2020

(51) Int. Cl. G06F 30/23; G01M 7/02; G06F 30/10; H04R 29/00

(52) U.S. Cl. CPC G06F 30/23; G01M 7/025; G06F 2111/10; H04R 29/001; G06F 30/10

(57) ABSTRACT

Systems and methods are provided for evaluating a device design to reduce audio speaker generated vibrational energy transfer between adjoining components of a device. The method performs a system-level modal analysis on the design to extract a natural frequency and a mode shape and thereafter create an analysis monitoring point on the design between two adjacent components defining a relative distance. Simulation inputs are fed into a linear dynamics finite element analysis (FEA) solver to solve system equations for a relative displacement of the two adjacent components at the analysis monitoring point, and if the solved relative displacement causes the relative distance to be equal to or less than a zero-relative distance value, then the device design is modified by at least one value of an element from one of the two adjacent components.

### BACKGROUND

Rattle noise or “rub and buzz” are part of a class of non-linear, irregular, impulsive and unwanted distortion effects, which are not normally found with production devices including audio speaker components, but are typically produced by mechanical, structural and assembly defects.

Many consumer electronics products with audio speaker devices exhibit irregular, transient disturbances, caused by mechanical artifacts resulting in acoustical noise problems. Consumer electronic products containing audio speakers may include, for example, TV sets, network-connected mobile communication devices, compressors, hearing aids, computers, automotive parts, electric drives, and Internet-of-Things (IoT) type devices.

Test procedures to detect “rub and buzz” on assembled products-are designed to detect the presence of higher frequency harmonic products produced in response to a low-frequency stimulus by an audio speaker component within the product. Typically, a defective product containing an audio speaker having a single frequency applied to the audio speaker, usually around 20 to 1000 Hz, may result in anything from a gentle to a harsh buzzing sound due to a defect-induced resonance being excited by the low frequency energy of the audio speaker. Typically, the defect-induced resonance is caused by two adjoining elements of the products that begin to mechanically interfere with one another upon the applied energy induced by the audio speaker.

### BRIEF SUMMARY

It should be appreciated that this Summary is provided to introduce a selection of concepts in a simplified form that are further described below in the Detailed Description. This Summary is not intended to be used to limit the scope of the claimed subject matter.

As disclosed herein, a method may evaluate a device design to reduce vibrational energy transfer between adjoining components of a device produced by an audio speaker component in the device by generating a configuration of a first device design including corresponding specifications for a plurality of components including an audio speaker component.

The method may include providing a computer including a processor and a memory communicably coupled to the processor, in which the memory includes computer instructions configured to cause the processor to receive the configuration of the first device design to generate a corresponding computer aided design (CAD) model, and perform a system-level modal analysis on the CAD model to extract a natural frequency and a mode shape of the CAD model.

The computer instructions may be configured to cause the processor to create, based on the extracted natural frequency and mode shape, an analysis monitoring point in the CAD model between at least two adjacent components of the plurality of components defining a relative distance between the at least two adjacent components; receive simulation input scheme values simulating parameters influenced by the vibrational energy transferred by the audio speaker component to the CAD model.

The computer instructions further may be configured to cause the processor to solve, using a linear dynamic finite element analysis (FEA) solver and the simulation input scheme values, system equations for a relative displacement of the at least two adjacent components at the analysis monitoring point.

The method may include generating a first risk assessment value based on the relative displacement of the analysis monitoring point and determining if the first risk assessment value is greater than an optimum design threshold risk value.

The method may include modifying the first device design, based on the determining the first risk assessment value to be greater than the optimum design threshold risk value, to create a second device design by modifying a dimensional value and/or a material characteristic value of an element from the at least two adjacent components.

As further disclosed herein, a method may evaluate a device design to reduce vibrational energy transfer between adjoining components of a device produced by an audio speaker component in the device by generating a configuration of a first device design, the configuration including corresponding specifications for a plurality of components including an audio speaker component and a housing for the audio speaker component, an enclosure for the first device, a display for the first device, a circuit board for the first device, a sensor for the first device, a power supply for the first device, a camera for the first device, a haptic feedback device for the first device, and/or an inertial measurement unit (IMU) for the first device.

The method may include providing a computer including a processor and a memory communicably coupled to the processor, in which the memory includes computer instructions configured to cause the processor to receive the configuration of the first device design and generate a corresponding CAD model, the CAD model of the first device design including the corresponding specifications for the plurality of components, and perform a system-level modal analysis on the CAD model to extract a natural frequency and a mode shape of the CAD model, one component of the plurality of components, and/or a constrained sub-set of components from the plurality of components.

The computer instructions may be configured to cause the processor to create, based on the extracted natural frequency and mode shape, an analysis monitoring point in the CAD model between one of at least two adjacent components of the plurality of components, or at least two constrained sub-sets of adjacent components of the plurality of components, the analysis monitoring point defining a relative distance between one of the at least two adjacent components, or the at least two constrained sub-sets of adjacent components.

The computer instructions may be configured to cause the processor to receive simulation input scheme values including an excitation frequency value to be simulated at the audio speaker component in the CAD model, an assembly gap design value and/or a dimensional tolerance value at the analysis monitoring point in the CAD model, and a system dampening value for the CAD model under influence of the excitation frequency value, and solve, using a linear dynamics finite element analysis (FEA) solver and the simulation input scheme values, system equations for a relative displacement of the analysis monitoring point.

The method may include generating a first risk assessment value by comparing the relative displacement of the analysis monitoring point with the assembly gap design value and/or the dimensional tolerance value at the analysis monitoring point.

The method may include the computer instructions further configured to generate a second risk assessment value by performing a statistical analysis of the relative displacement of the analysis monitoring point through modal contribution and sensitivity analysis.

The method may include determining if one of the first risk assessment value, the second risk assessment value or a sum of the first and second risk assessment values is greater than an optimum design threshold risk value.

The method may include modifying the first device design based on the determining that one of the first, second or sum of first and second risk assessment values is greater than the optimum design threshold risk value, to create a second device design by modifying a value of an element from one of the at least two adjacent components or the at least two constrained sub-sets of adjacent components.

As disclosed herein, a method evaluates a device design to reduce vibrational energy transfer between adjoining components of a device produced by an audio speaker component in the device generates a configuration of a first device design, the configuration including corresponding specifications for a plurality of components including an audio speaker component.

The method may include providing a computer including a processor and a memory communicably coupled to the processor, in which the memory includes computer instructions configured to cause the processor to receive the configuration of the first device design to generate a corresponding CAD model; perform a system-level modal analysis on the CAD model to extract a natural frequency and a mode shape of the CAD model, and create, based on the extracted natural frequency and mode shape, an analysis monitoring point in the CAD model between at least two adjacent components of the plurality of components defining a relative distance between the at least two adjacent components.

The computer instructions may be configured to cause the processor to receive simulation input scheme values simulating parameters influenced by the vibrational energy transferred by the audio speaker component to the CAD model, and solve, using a linear dynamics finite element analysis (FEA) solver and the simulation input scheme values, system equations for a relative displacement of the at least two adjacent components at the analysis monitoring point.

The method may include determining if the solved relative displacement causes the relative distance to be equal to or less than a zero-relative distance value.

The method may include modifying, based on determining the relative displacement causes the relative distance to be equal to or less than the zero-relative distance value, the first device design to create a second device design by modifying a value of an element from one of the at least two adjacent components of the plurality of components,

The method may include the modification of the value in anticipation of a non-zero value relative displacement at the analysis monitoring point between the at least two adjacent components.

A system for evaluating a device design, wherein the system includes a memory configured to store processor instructions; and a processor in communication with the memory. The processor is configured to execute the processor instructions to perform: generating a configuration of a first device design, the configuration comprising corresponding specifications for a plurality of components including at least one audio speaker component; obtaining a computerized model of the first device design; extracting a natural frequency and a mode shape of the computerized model of the first device design; creating, based on the extracted natural frequency and mode shape, at least one analysis monitoring point in the computerized model between at least two adjacent components of the plurality of components defining a relative distance between the at least two adjacent components; receiving simulation input scheme values simulating parameters influenced by the vibrational energy transferred by the at least one audio speaker component to the computerized model; determining a relative displacement of the at least two adjacent components at the at least one analysis monitoring point; generating a first risk assessment value based on the relative displacement of the at least one analysis monitoring point; determining that the first risk assessment value is greater than an optimum design threshold risk value; and responsive to determining that the first risk assessment value is greater than the threshold risk value, modifying the first device design to create a second device design by modifying at least one of a dimensional value or a material characteristic value of at least one element from the at least two adjacent components.

A non-transitory computer-readable medium storing computer code for controlling a processor to cause the processor to perform a method, the computer code including instructions to cause the processor to: generate a configuration of a first device design, the configuration comprising corresponding specifications for a plurality of components including at least one audio speaker component; obtain a computerized model of the first device design; extract a natural frequency and a mode shape of the computerized model of the first device design; create, based on the extracted natural frequency and mode shape, at least one analysis monitoring point in the computerized model between at least two adjacent components of the plurality of components defining a relative distance between the at least two adjacent components; receive simulation input scheme values simulating parameters influenced by the vibrational energy transferred by the at least one audio speaker component to the computerized model; determine a relative displacement of the at least two adjacent components at the at least one analysis monitoring point; generate a first risk assessment value based on the relative displacement of the at least one analysis monitoring point; determine that the first risk assessment value is greater than an optimum design threshold risk value; and responsive to determining that the first risk assessment value is greater than the threshold risk value, modify the first device design to create a second device design by modifying at least one of a dimensional value or a material characteristic value of at least one element from the at least two adjacent components.

### BRIEF DESCRIPTION OF THE SEVERAL VIEWS OF THE DRAWINGS

The methods disclosed herein will be better understood from the following detailed description with reference to the drawings, which are not necessarily drawing to scale and in which:

FIG. 1A illustrates a side view of a consumer product containing an audio speaker;

FIG. 1B illustrates a perspective view of the consumer product containing the audio speaker of FIG. 1A;

FIG. 2A illustrates an exploded side view of the consumer product containing an audio speaker of FIGS. 1A-1B;

FIG. 2B illustrates an exploded perspective view of the consumer product containing an audio speaker of FIGS. 1A-1B and 2A;

FIG. 3 depicts a logic flow chart of a process for evaluating a device design to reduce vibrational energy transfer between adjoining components of a device produced by an audio speaker component in the device;

FIG. 4 depicts a graph of relative displacement of the analysis monitoring point through modal contribution and sensitivity analysis;

FIG. 5 depicts a chart with results of a statistical analysis of the relative displacement of the analysis monitoring point through modal contribution and sensitivity analysis;

FIG. 6 depicts another logic flow chart of a process for evaluating a device design to reduce vibrational energy transfer between adjoining components of a device produced by an audio speaker component in the device;

FIG. 7 illustrates a method for evaluating a device design to reduce vibrational energy transfer between adjoining components of a device produced by an audio speaker component in the device;

FIG. 8 illustrates the remaining portions of FIG. 7 of the method of evaluating a device design to reduce vibrational energy transfer between adjoining components of a device produced by an audio speaker component in the device;

FIG. 9 illustrates another method for evaluating a device design to reduce vibrational energy transfer between adjoining components of a device produced by an audio speaker component in the device;

FIG. 10 illustrates the remaining portions of FIG. 9, of the method of evaluating a device design to reduce vibrational energy transfer between adjoining components of a device produced by an audio speaker component in the device;

FIG. 11 illustrates a computer according to the disclosed subject matter; and,

FIG. 12 illustrates a network configuration according to the disclosed subject matter.

### DETAILED DESCRIPTION

Detecting “rub and buzz” in the post-production phase may require testing a range of applied frequencies on an assembled product to find the specific frequency or frequencies that cause the mechanical interference to occur. For example, a first frequency at 110 Hz may cause a significant amount of audible “rub and buzz” to occur in a product with an audio speaker, but nearby frequencies on either side of the first frequency may not cause the defect-induced resonance problem. Identification of problem frequencies that cause the resonant excitation may be performed by a frequency range sweep from 20 Hz to 2 kHz.

Testing of assembled products may require generating output to an audio speaker in the device with a test frequency, or swept frequency range. A microphone then captures a full spectrum frequency range produced by the assembled product including the test frequency, and isolates any frequency produced by the assembled product outside of the test frequency and determines an amplitude of the isolated frequency. If the amplitude of the isolated frequency is above a particular threshold sufficient to be audibly perceived by a user of assembled device, then the test procedure has located a frequency at which a defect-induced resonance occurs.

The test procedure generally described above may require a finally assembled product. The cost to modify and manufacture a new design to correct “rub and buzz” problems of a fully assembled product is expensive and time consuming. There exists a need for testing the designs of products intended to be manufactured without having to fully manufacture them or produce prototypes for testing. Being able to test a product design before physical manufacturing saves expense and development time in the product engineering lifecycle. Another benefit of the proposed testing methodology is for root cause analysis and mitigation of potential issues that may be later identified during the manufacturing process when it is expensive to correct and remediate.

The methods presented herein are directed to pre-production testing of designs of products intended to be manufactured without necessitating the manufacture or production of prototypes for pre-production testing. Testing product designs for “rub and buzz” before physical manufacturing may save expense and development time in the product engineering lifecycle and provides for root problem cause analysis. Testing in the pre-production or pre-prototype phase also may allow for quick and inexpensive design changes and mitigates potential design failure that may later manifest in the manufacturing process when it is expensive to correct and remediate.

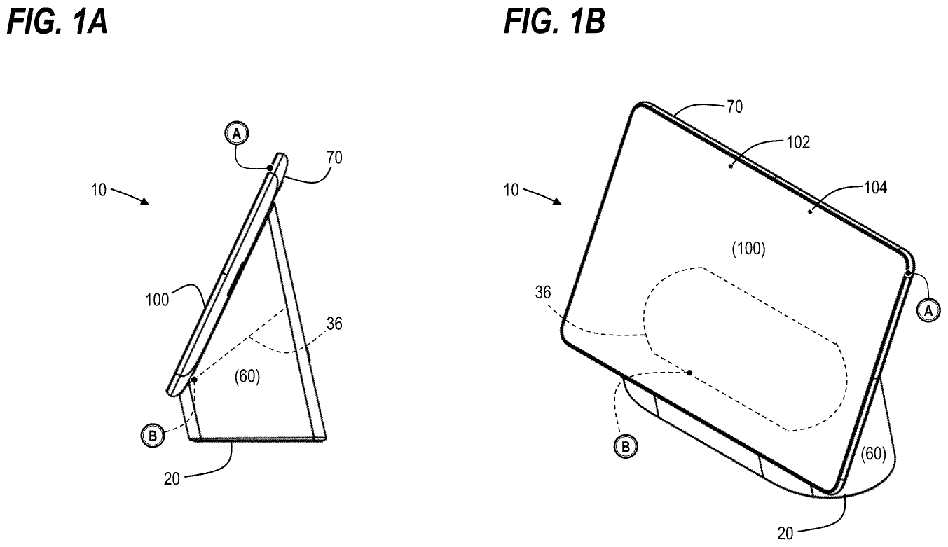

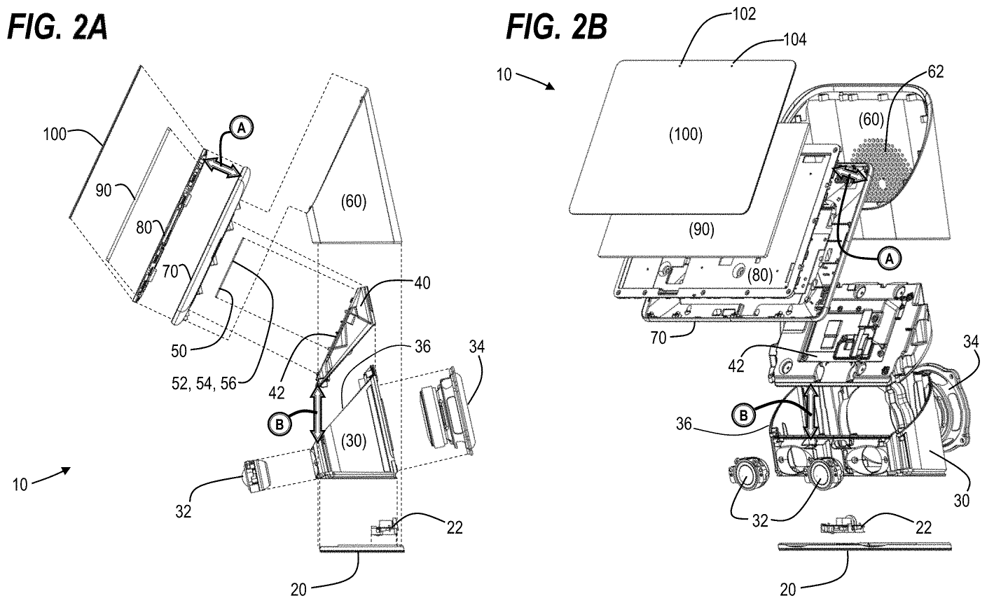

FIGS. 1A and 1B illustrate a side and perspective view, respectively, and FIGS. 2A and 2B illustrate an exploded side and perspective view, respectively, of a consumer electronic product 10 containing an audio speaker used as an example to demonstrate the methods presented herein for evaluating a device design to reduce vibrational energy transferred between adjoining components of a device produced by an audio speaker. The methods described herein will be applied in a representative fashion to the consumer electronic product 10 for illustrative purposes.

FIGS. 1A-2B illustrate a consumer electronic device 10 as an Internet-of-Things (IoT) type, network connected device. FIG. 2A additionally illustrates broken assembly lines depicting the assembly orientation of the respective elements.

The consumer electronic device 10 includes a base 20 capable of supporting the device 10 on a flat surface. A power supply port 22 is located proximate the base 20 and a rear external surface of the device 10 configured to be connected to a wired power supply. In the alternative, device 10 may have power supplied via an internal rechargeable battery (not shown) as commonly known in the art.

Device 10 further includes a speaker enclosure 30 that, in this illustrative example, includes two front mounted stereo audio speakers 32 and a single rear mounted audio speaker 34. A lower portion of the speaker enclosure 30 is attached to the base 20, while a speaker enclosure top surface 36 supports a circuit board mounting enclosure 40 providing a recessed circuit board mounting interface 42 to secure a circuit board 50 thereto.

The circuit board 50 may further include, or be in communication with, a sensor 52, (for example, atmospheric sensors, including a temperature sensor, a pressure sensor, a humidity sensor, light sensor, radar sensor, thermal sensor, and/or LiDAR sensor), a haptic feedback device 54, and/or an inertial measurement unit (IMU) 56.

A neck enclosure 60 covers an upper portion of the base 20 and surrounds the speaker enclosure 30, the circuit board mounting enclosure 40 and connects to a rear portion of a display housing 70. The neck enclosure 60 further includes a rear speaker grill 62 for the rearward facing speaker 34.

The display housing 70 further surrounds and provides support for a display frame 80 configured to support a display panel 90 therein. A display touch panel 100 encloses the display housing in front of the display panel 90 and provides an aperture for a forward-facing camera 102 on a top portion thereof, and an aperture for a microphone 104 mounted in a similar fashion.

Although the device 10 is generally represented with the above-identified numbered elements, many more components, sub-assemblies of a components, electrical connections, and fasteners are not identified herein for clarity purposes. However, each of the components, sub-assemblies of components, electrical connections and fasteners may be subject to the methods described herein to evaluate the total design to reduce vibrational energy transfer between each of these adjoining components produced by an audio speaker(s), for example, speakers 32 and 34.

For one representative example, a first analysis monitoring point A, illustrated as an encircled “A” in FIGS. 1A-2B, may be identified to evaluate the likelihood of “rub and buzz” between a point, or design dimensional gap, between the display frame 80 and display housing 70, as illustrated in the exploded illustrations of FIGS. 2A-2B. The methods described herein may test for the likelihood of the design at the analysis monitoring point A under a simulation of vibrational energy from any, or particular ones, of the audio speakers 32 and 34 at various frequencies and amplitudes, transferred from the display frame 80 to the display housing 70, or visa-versa, for the design gap between the two components to be closed under the influence of a corresponding amplitude and frequency of the audio speaker vibrational energy.

Although the front 32 and rear 34 audio speakers are not in direct contact with either of the display housing frame 70 or the display frame 80, vibrational energy may be transferred via, for example, the circuit board mounting enclosure 40 or the neck enclosure 60, or any other component or sub-assembly of components that may influence the vibrational energy being transferred by the audio speakers 32 and 34 to the first analysis monitoring point A between the display housing frame 70 or the display frame 80.

In another representative example, a second analysis monitoring point B, illustrated as an encircled “B” in FIGS. 1A-2B, may be identified to evaluate the likelihood of “rub and buzz” between another point on the design of the device 10, or design dimensional gap, between the speaker enclosure 30 and circuit board mounting enclosure 40, as illustrated in the exploded FIGS. 2A-2B. The methods described herein may test for the likelihood of the design at the analysis monitoring point B under a simulation of vibrational energy from any, or particular ones, of the audio speakers 32 and 34 at various frequencies and amplitudes, transferred from the speaker enclosure 30 to the circuit board mounting enclosure 40, for the design gap between the two components to be closed under the influence of a corresponding amplitude and frequency of the audio speaker vibrational energy.

In this example, the front 32 and rear 34 audio speakers are in direct contact with the speaker enclosure 30, and vibrational energy from the speakers 32 and 34 will be transferred via the speaker enclosure 30 to the circuit board mounting enclosure 40. The second analysis monitoring point B, for example, is selected to determine whether a design gap between the speaker enclosure 30 and the circuit board mounting enclosure 40 under a simulation of vibration energy produced by the speakers 32 and/or 34, causes the design gap at the second analysis monitoring point B to close, and therefore indicate a likelihood of “rub and buzz.”

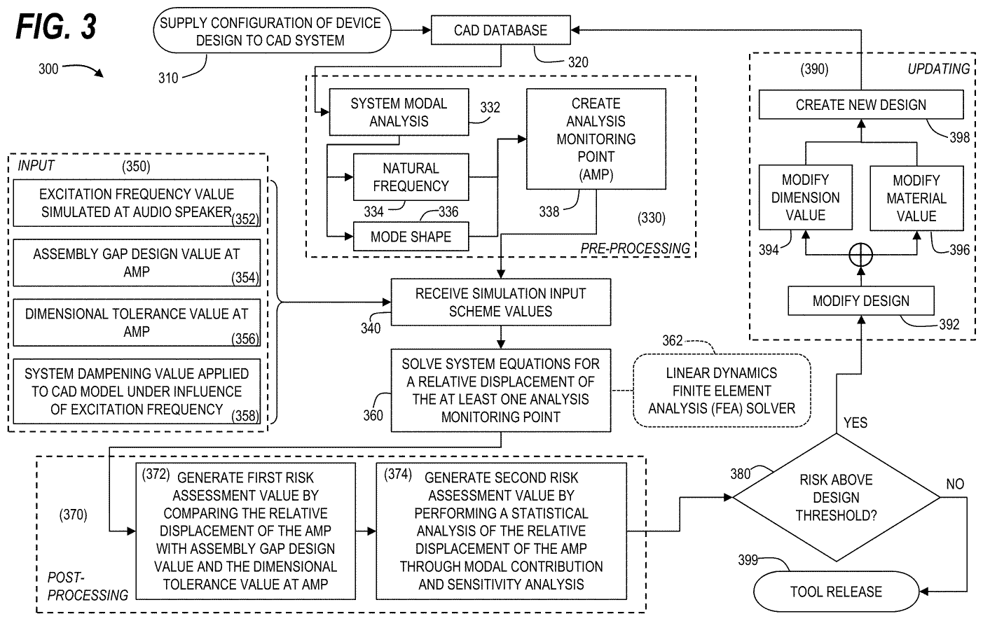

FIG. 3 depicts an example of a process 300 for evaluating a device design to reduce vibrational energy transfer between adjoining components of a device produced by an audio speaker component in the device as disclosed herein.

The process may include supplying 310 a configuration of a first device design to a computer aided design (CAD) system database 320. For example, the configuration may include corresponding specifications for a plurality of components including an audio speaker component and may include other components, (for example, a housing for the audio speaker component, an enclosure for the first device, a display for the first device, a circuit board for the first device, a sensor for the first device, a power supply for the first device, a camera for the first device, a haptic feedback device for the first device, and an inertial measurement unit (IMU) for the first device).

A computer including a processor and a memory communicably coupled to the processor may include computer instructions configured to cause the processor to operate a CAD system that generates a computerized design model, and retrieve designs from the CAD database. The supplied configuration of the first device design and generates a corresponding computerized model, where the computerized model of the first device design includes the corresponding specifications for the supplied plurality of components.

A pre-processing phase 330 performs a system-level modal analysis 332 on the computerized model to extract a natural frequency 334 and a mode shape 336 of the entire computerized model, a component of the plurality of components within the computerized model, and/or a constrained sub-set of components from the plurality of components within the computerized model. The first few high energy mode shapes are examined to assess risk of rub and buzz at critical interfaces between components. The risk of rub and buzz is highest for the low frequency modes due to the higher amount of energy associated with them.

The pre-processing phase 330 further includes the creation of, based on the extracted natural frequency and mode shape, an analysis monitoring point (AMP) in the computerized model between 1) two adjacent components of the plurality of components, and/or 2) two constrained sub-sets of adjacent components of the plurality of components, (compare, for example, points “A” and “B” in FIGS. 1A-2B). The analysis monitoring point may define a relative distance between one of the two adjacent components, and/or the two constrained sub-sets of adjacent components.

At 340 simulation input scheme values may be received from an input phase 350, including 1) an excitation frequency value 352 to be simulated at the audio speaker component in the computerized model, 2) an assembly gap design value 354 at the analysis monitoring point in the computerized model, 3) a dimensional tolerance value 356 at the least one analysis monitoring point in the computerized model, and 4) a system dampening value 358 for the computerized model under influence of the excitation frequency value.

The process then solves 360 system equations for a relative displacement of the analysis monitoring point, for example, using a linear dynamics finite element analysis (FEA) solver 362 and the simulation input scheme values from input phase 350.

A post-processing phase 370 may include generating 372 a first risk assessment value by comparing the relative displacement of the analysis monitoring point with the assembly gap design value and/or the dimensional tolerance value at the analysis monitoring point.

The post-processing phase 370 may include an optional or alternative step of generating 374 a second risk assessment value by performing a statistical analysis of the relative displacement of the analysis monitoring point through modal contribution and sensitivity analysis.

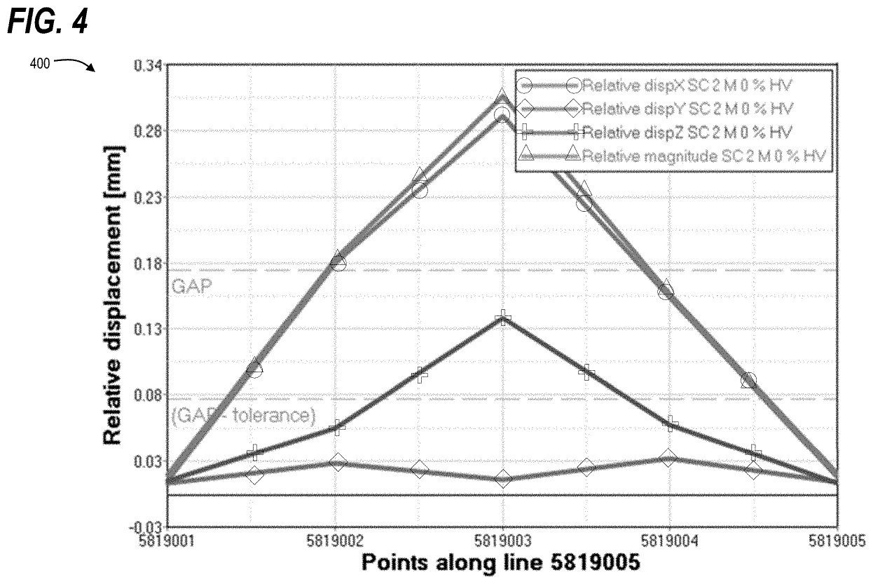

FIG. 4 illustrates a modal contribution analysis of relative displacement for four modes along an exemplary point along line “5819005.” FIG. 4 depicts a graph of relative displacement of the analysis monitoring points at the interface of two components within the product. Gap and tolerance values for the particular interface are also shown. Relative displacement along the X, Y, Z coordinates as well as the resultant magnitude are shown on the plot. The relative displacement value exceeding the gap represents risk of rub and buzz at the monitoring points along the interface.

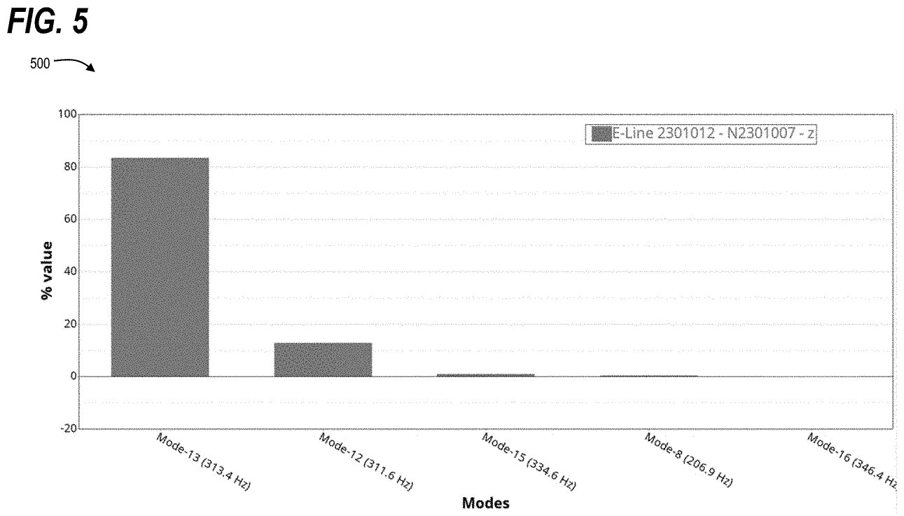

FIG. 5 illustrates a statistical analysis of different analysis points at different frequency modes for a percentage (%) value. FIG. 5 depicts a chart with modal contribution analysis of an example monitoring point along a component interface. The chart shows percentage contribution from various modes to the relative displacement at that monitoring point. For example, in this chart, mode 12 has the highest contribution (above 90%) to the relative displacement, whereas modes 1, 10, 6, etc., have lower (below 10%) contributions. This signifies whether “rub and buzz” is isolated to a narrow frequency band or affected by a wider frequency range.

The method then determines 380 if either the first generated risk assessment value 372, the second generated risk assessment value 374 or a sum of the first and second risk assessment values is greater than an optimum design threshold risk value.

If either single risk assessment value, or the sum of the risk assessment values is greater than the optimum design threshold risk value, an updating phase may be implemented at 390 to modify 392 the first device design by modifying a dimension value 394 and/or modifying a material value 396 of an element from the two adjacent components and/or the two constrained sub-sets of adjacent components, to create a new modified device design 398. The new modified design may be iteratively submitted to the CAD database 320 and is further processed by the pre-processing phase 330, the input value phase 350, to solve for the relative displacement of the analysis monitoring point to be subsequently submitted to the post-processing phase 370.

If any risk assessment value individually, and the sum of the risk assessment values is less than the optimum design threshold risk value, then the device design may be released for tooling 399.

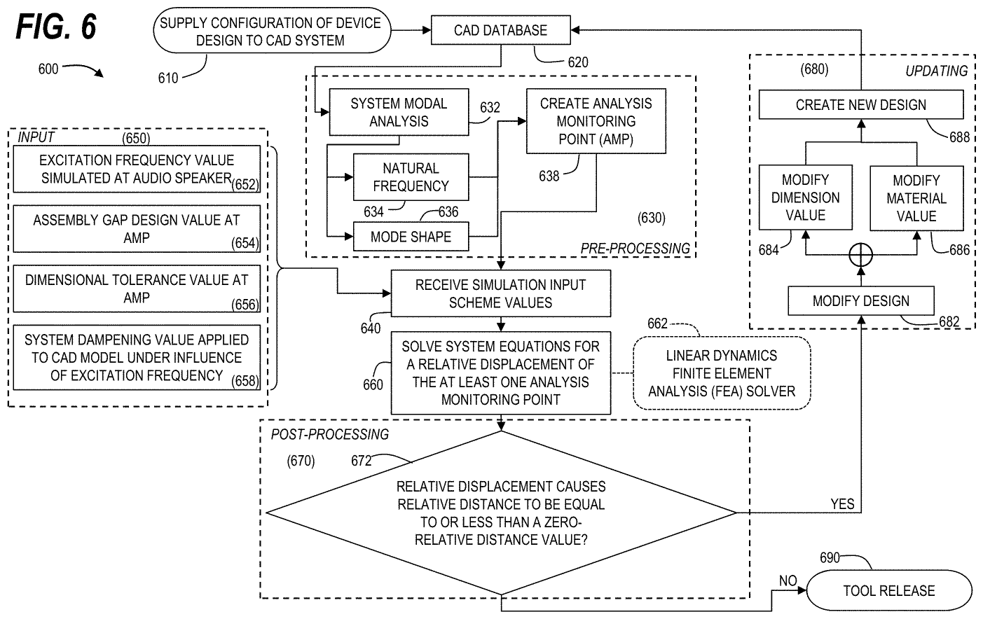

FIG. 6 depicts a logic flow chart 600 of a process for evaluating a device design to reduce vibrational energy transfer between adjoining components of a device produced by an audio speaker component in the device.

The process may include supplying 610 a configuration of a first device design to a CAD system database 620. The configuration includes corresponding specifications for a plurality of components including an audio speaker component and may include other components, for example, a housing for the audio speaker component, an enclosure for the first device, a display for the first device, a circuit board for the first device, a sensor for the first device, a power supply for the first device, a camera for the first device, a haptic feedback device for the first device, and an inertial measurement unit (IMU) for the first device.

A computer similarly includes a processor and a memory communicably coupled to the processor includes computer instructions configured to cause the processor to operate the CAD system and retrieve designs from the CAD database. The supplied configuration of the first device design and generates a corresponding computerized model, where the CA computerized D model of the first device design includes the corresponding specifications for the supplied plurality of components.

A pre-processing phase 630 performs a system-level modal analysis 632 on the computerized model to extract a natural frequency 634 and a mode shape 636 of the entire computerized model, a component of the plurality of components within the computerized model, and/or a constrained sub-set of components from the plurality of components within the computerized model.

The pre-processing phase 630 further includes the creation of, based on the extracted natural frequency and mode shape, an analysis monitoring point (AMP) in the computerized model between 1) two adjacent components of the plurality of components, and/or 2) two constrained sub-sets of adjacent components of the plurality of components, (compare, for example, points “A” and “B” in FIGS. 1A-2B). The analysis monitoring point may define a relative distance between one of the two adjacent components, and/or the two constrained sub-sets of adjacent components.

The method further receives 640 simulation input scheme values from an input phase 650, including 1) an excitation frequency value 652 to be simulated at the audio speaker component in the computerized model, 2) an assembly gap design value 654 at the analysis monitoring point in the computerized model, 3) a dimensional tolerance value 656 at the least one analysis monitoring point in the computerized model, and 4) a system dampening value 658 for the computerized model under influence of the excitation frequency value.

The method then solves 660, using a linear dynamics finite element analysis (FEA) solver 662 and the simulation input scheme values from input phase 650, system equations for a relative displacement of the analysis monitoring point.

A post-processing phase 670 includes determining 672 if the solved relative displacement causes the relative distance to be equal to or less than a zero-relative distance value.

If the relative displacement causes the relative distance to be equal to or less than the zero-relative distance value, the first device design is subject to the updating phase 680 to modify 682 the first device design by modifying a dimension value 684 and/or modifying a material value 686 of an element from the two adjacent components and/or the two constrained sub-sets of adjacent components to create a new modified device design 688.

The modification of the dimensional value 684 and/or the material characteristic value 686 anticipates a non-zero value relative displacement at the analysis monitoring point between the two adjacent elements and/or the constrained sub-sets of adjacent components.

The new modified design is iteratively submitted to the CAD database 620 and is further processed by the pre-processing phase 630, the input value phase 650, to solve for the relative displacement of the analysis monitoring point to be subsequently submitted to the post-processing phase 670.

If any risk assessment value individually, and the sum of the risk assessment values is less than the optimum design threshold risk value, then the device design may be released for tooling 690.

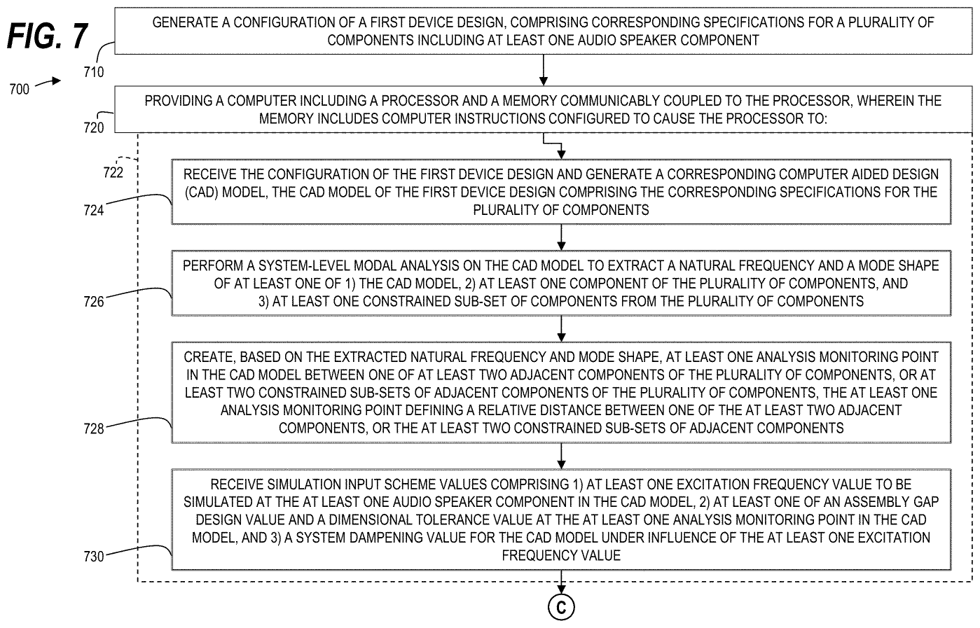

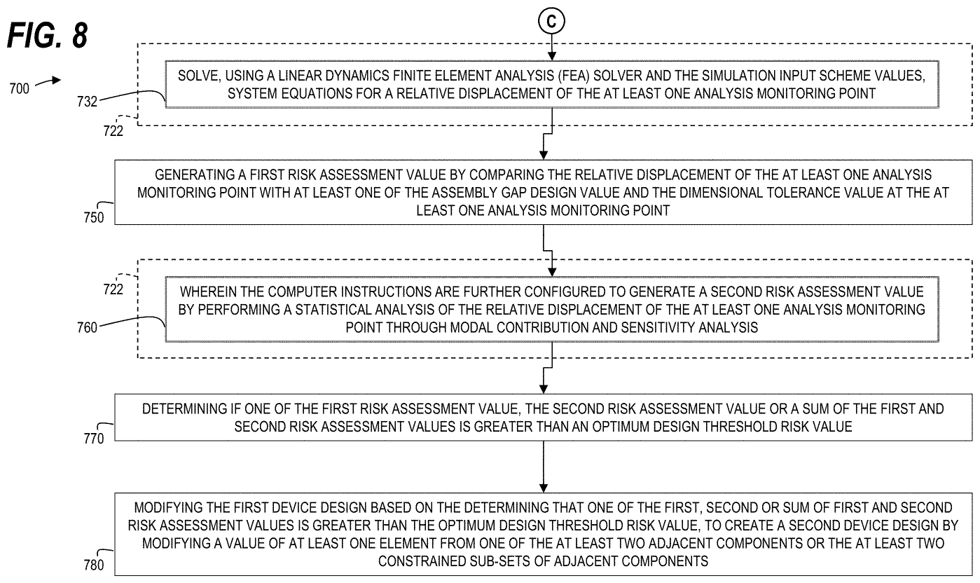

FIG. 7 illustrates a method 700 of evaluating a device design to reduce vibrational energy transfer between adjoining components of a device produced by an audio speaker component in the device. FIG. 8 illustrates the remaining portions of FIG. 7 the method 700 of evaluating a device design to reduce vibrational energy transfer between adjoining components of a device produced by an audio speaker component in the device.

The method of FIGS. 7 and 8 generates a configuration of a first device design, the configuration including corresponding specifications for a plurality of components including an audio speaker component and a housing for the audio speaker component, an enclosure for the first device, a display for the first device, a circuit board for the first device, a sensor for the first device, a power supply for the first device, a camera for the first device, a haptic feedback device for the first device, and/or an inertial measurement unit (IMU) for the first device.

The method provides 720 a computer including a processor and a memory communicably coupled to the processor, in which the memory includes computer instructions configured to cause the processor to perform steps identified by as included in the dashed line 722.

The computer instructions are further configured to cause the processor to receive 724 the configuration of the first device design and generate a corresponding computerized model, where the computerized model of the first device design includes the corresponding specifications for the plurality of components.

The computer instructions are further configured to cause the processor to perform 726 a system-level modal analysis on the computerized model to extract a natural frequency and a mode shape of the computerized model, one component of the plurality of components, and/or a constrained sub-set of components from the plurality of components.

The computer instructions are further configured to cause the processor to create 728, based on the extracted natural frequency and mode shape, an analysis monitoring point in the computerized model between one of at least two adjacent components of the plurality of components, or at least two constrained sub-sets of adjacent components of the plurality of components, the analysis monitoring point defining a relative distance between one of the at least two adjacent components, or the at least two constrained sub-sets of adjacent components.

The computer instructions are further configured to cause the processor to receive 730 simulation input scheme values including 1) an excitation frequency value to be simulated at the audio speaker component in the computerized model, 2) an assembly gap design value, 3) a dimensional tolerance value at analysis monitoring point in the computerized model, and/or 4) a system dampening value for the computerized model under influence of the excitation frequency value.

The computer instructions are further configured to cause the processor (denoted by dashed line box 722) to solve 732, using a linear dynamics finite element analysis (FEA) solver and the simulation input scheme values, system equations for a relative displacement of the analysis monitoring point.

The method further includes generating 750 a first risk assessment value by comparing the relative displacement of the analysis monitoring point with the assembly gap design value and/or the dimensional tolerance value at the analysis monitoring point.

The computer instructions are further configured to cause the processor (denoted by dashed line box 722) to generate 760 a second risk assessment value by performing a statistical analysis of the relative displacement of the analysis monitoring point through modal contribution and sensitivity analysis.

The method further includes determining 770 if one of the first risk assessment value, the second risk assessment value or a sum of the first and second risk assessment values is greater than an optimum design threshold risk value.

The method further includes modifying 780 the first device design based on the determining that one of the first, second or sum of first and second risk assessment values is greater than the optimum design threshold risk value, to create a second device design by modifying a value of an element from one of the at least two adjacent components or the at least two constrained sub-sets of adjacent components.

Various alternative or additional features may be implemented in any of the systems and techniques disclosed herein. For example, corresponding specifications for the plurality of components may further include dimensional values and material values for each of the plurality of components.

As another example, techniques disclosed herein may empirically obtain the excitation frequency value from data obtained by a laser vibrometer recording displacement value of the device corresponding to an excitation frequency value applied to the device.

The method further creates the second device design may further modify a dimensional value of the one element from one of the at least two adjacent components or the two constrained sub-sets of adjacent components.

The method further creates the second device design may further modify a material characteristic value of the element from one of the at least two adjacent components or the at least two constrained sub-sets of adjacent components.

The method may further evaluate a device design to reduce vibrational energy transfer between adjoining components of a device produced by an audio speaker component in the device, includes generating a configuration of a first device design, the configuration including corresponding specifications for a plurality of components including an audio speaker component.

The method further provides a computer including a processor and a memory communicably coupled to the processor, in which the memory includes computer instructions configured to cause the processor to receive the configuration of the first device design to generate a corresponding computerized model.

The computer instructions may be further configured to cause the processor to perform a system-level modal analysis on the computerized model to extract a natural frequency and a mode shape of the computerized model.

The computer instructions may be further configured to cause the processor to create, based on the extracted natural frequency and mode shape, an analysis monitoring point in the computerized model between at least two adjacent components of the plurality of components defining a relative distance between the at least two adjacent components.

The computer instructions may be further configured to cause the processor to receive simulation input scheme values simulating parameters influenced by the vibrational energy transferred by the audio speaker component to the computerized model.

The computer instructions may be further configured to cause the processor to solve, using a linear dynamics finite element analysis (FEA) solver and the simulation input scheme values, system equations for a relative displacement of the at least two adjacent components at the analysis monitoring point.

The method may further generate a first risk assessment value based on the relative displacement of the analysis monitoring point.

The computer instructions may be further configured to cause the processor to determine if the first risk assessment value is greater than an optimum design threshold risk value.

The method may further modify the first device design based on the determining the first risk assessment value is greater than the optimum design threshold risk value, to create a second device design by modifying a dimensional value and/or a material characteristic value of one element from the two adjacent components.

The plurality of components may further include a housing for the one audio speaker component, an enclosure for the first device, a display for the first device, a circuit board for the first device, a sensor for the first device, a power supply for the first device, a camera for the first device, a haptic feedback device for the first device, and/or an inertial measurement unit (IMU) for the first device.

The computer instructions may be further configured to cause the processor to perform the system-level modal analysis on the computerized model to further extract the natural frequency and the mode shape of: one component of the plurality of components; and/or a constrained sub-set of components from the plurality of components.

The analysis monitoring point may be between at least two constrained sub-sets of adjacent components defining the relative distance between the at least two constrained sub-sets of adjacent components.

The computer instructions are further configured to cause the processor to solve, using the linear dynamics finite element analysis (FEA) solver, the system equations having the simulation input scheme values for the relative displacement of the at least two constrained sub-sets of adjacent components at the analysis monitoring point.

The method further includes modifying the first device design based on the determining the first risk assessment value is greater than the optimum design threshold risk value, to create the second device design by modifying one of a dimensional value or a material characteristic value of an element from the two constrained sub-sets of adjacent components.

The method further includes the simulation input scheme values further including: 1) an excitation frequency value to be simulated at the audio speaker component in the computerized model; 2) an assembly gap design value at the analysis monitoring point in the computerized model, 3) a dimensional tolerance value at the analysis monitoring point in the computerized model; and 4) a system dampening value in the computerized model under influence of the excitation frequency value.

The method further includes generating the first risk assessment value further including comparing the relative displacement of the analysis monitoring point with the assembly gap design value and/or the dimensional tolerance value at the analysis monitoring point.

The computer instructions are further configured to cause the processor to generate a second risk assessment value by performing a statistical analysis of the relative displacement of the analysis monitoring point through modal contribution and sensitivity analysis.

The method further includes determining if one of the first risk assessment value, the second risk assessment value or a sum of the first and second risk assessment values is greater than the optimum design threshold risk value.

The method further includes modifying the first device design being further based on the determining that one of the first, second or sum of first and second risk assessment values is greater than the optimum design threshold risk value, to create the second device design.

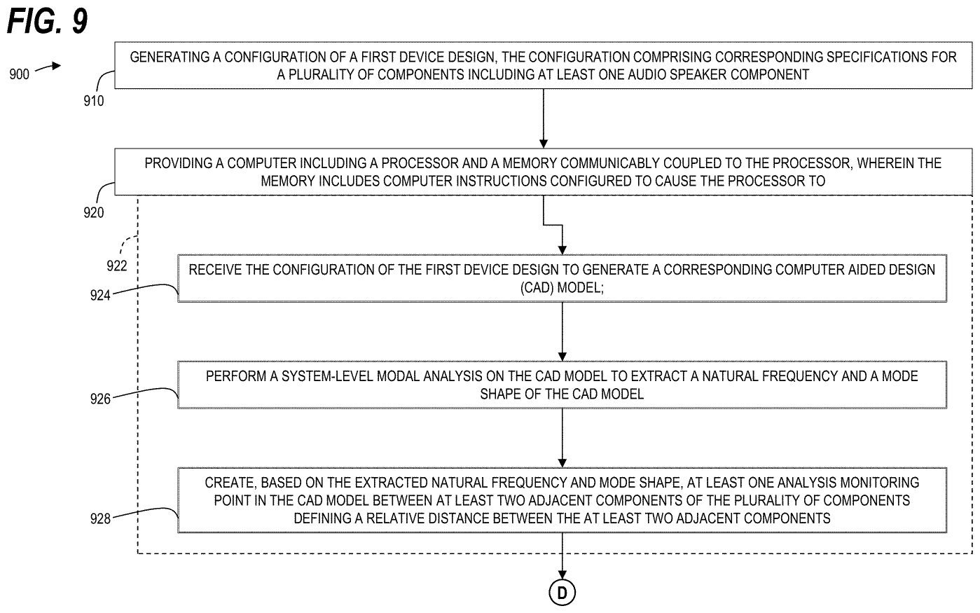

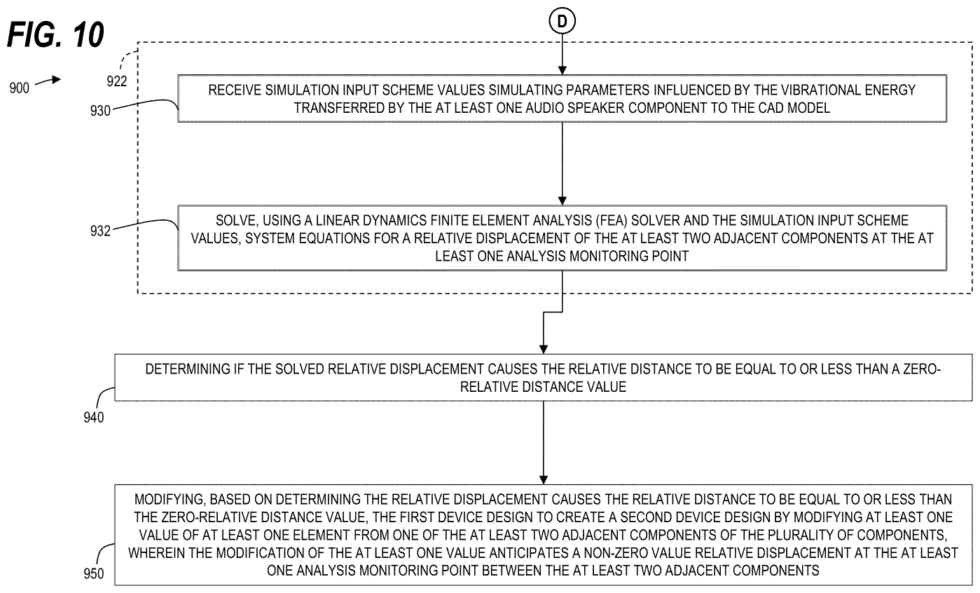

FIG. 9 illustrates a method 900 of evaluating a device design to reduce vibrational energy transfer between adjoining components of a device produced by an audio speaker component in the device. FIG. 10 illustrates the remaining portions of FIG. 9, of the method 900 of evaluating a device design to reduce vibrational energy transfer between adjoining components of a device produced by an audio speaker component in the device.

The method 900 of FIGS. 9 and 10 includes generating 910 a configuration of a first device design, the configuration including corresponding specifications for a plurality of components including an audio speaker component.

The method further includes providing 920 a computer including a processor and a memory communicably coupled to the processor, in which the memory includes computer instructions configured to cause the processor to perform steps identified by as included in the dashed line 922.

The computer instructions are further configured to cause the processor to receive 924 the configuration of the first device design to generate a corresponding computerized model.

The computer instructions are further configured to cause the processor to perform 926 a system-level modal analysis on the computerized model to extract a natural frequency and a mode shape of the computerized model.

The computer instructions are further configured to cause the processor to create 928, based on the extracted natural frequency and mode shape, an analysis monitoring point in the computerized model between at least two adjacent components of the plurality of components defining a relative distance between the at least two adjacent components.

The computer instructions are further configured to cause the processor to receive 930 simulation input scheme values simulating parameters influenced by the vibrational energy transferred by the audio speaker component to the computerized model.

The computer instructions are further configured to cause the processor to solve 932, using a linear dynamics finite element analysis (FEA) solver and the simulation input scheme values, system equations for a relative displacement of the at least two adjacent components at the analysis monitoring point.

The method further includes determining 940 if the solved relative displacement causes the relative distance to be equal to or less than a zero-relative distance value, and modifying 950, based on determining the relative displacement causes the relative distance to be equal to or less than the zero-relative distance value, the first device design to create a second device design by modifying a value of an element from one of the two adjacent components of the plurality of components, in which the modification of the value anticipates a non-zero value relative displacement at the one analysis monitoring point between the two adjacent components.

The method may further include the modified value of the element includes a dimensional value of the element from one of the two adjacent components, and a material characteristic value of an element from one of the two adjacent components.

The method may further include the modified value of the one element includes least one of a dimensional value of the one element from one of two constrained sub-sets of adjacent components, and a material characteristic value of the one element from one of two constrained sub-sets of adjacent components.

The method may further include the modification of one of the dimensional values and the material characteristic value anticipating a non-zero value relative displacement at the analysis monitoring point between the at least two constrained sub-sets of adjacent components.

Implementations of the presently disclosed subject matter may be implemented in and used with a variety of component and network architectures.

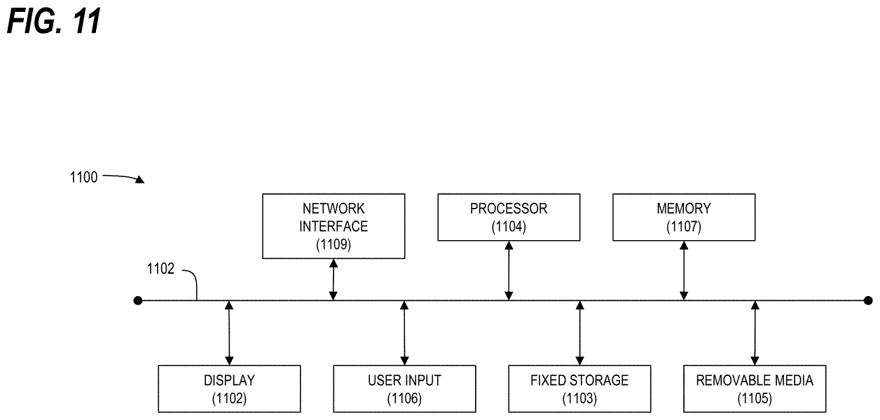

FIG. 11 is an example computer 1100 suitable for implementations of the presently disclosed subject matter. The computer 1100 includes a bus 1101 which interconnects major components of the computer 1100, such as a central processor 1104, a memory 1107 (typically RAM, but which may also include ROM, flash RAM, or the like), an input/output controller 1108, a user display 1102, such as a display screen via a display adapter, a user input interface 1106, which may include one or more controllers and associated user input devices such as a keyboard, mouse, and the like, and may be closely coupled to the I/O controller 1108, fixed storage 1103, such as a hard drive, flash storage, Fiber Channel network, SAN device, SCSI device, and the like, and a removable media component 1105 operative to control and receive an optical disk, flash drive, and the like.

The bus 1101 allows data communication between the central processor 1104 and the memory 1107, which may include read-only memory (ROM) or flash memory (neither shown), and random-access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 1100 are generally stored on and accessed via a computer readable medium, such as a hard disk drive (e.g., fixed storage 1103), an optical drive, floppy disk, or other storage medium 1105.

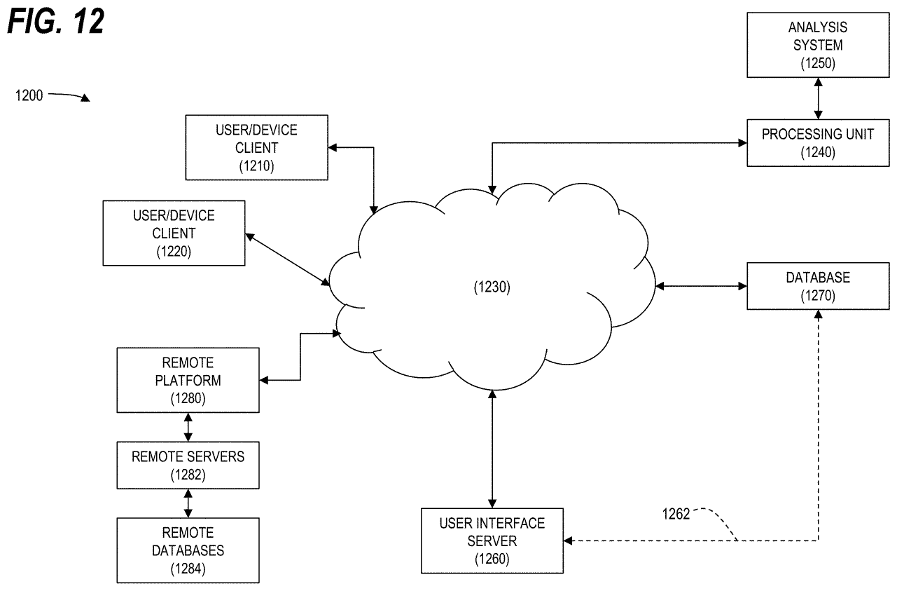

The fixed storage 1103 may be integral with the computer 1100 or may be separate and accessed through other interfaces. A network interface 1109 may provide a direct connection to a remote server via a telephone link, to the Internet via an internet service provider (ISP), or a direct connection to a remote server via a direct network link to the Internet via a POP (point of presence) or other technique. The network interface 1109 may provide such connection using wireless techniques, including digital cellular telephone connection, Cellular Digital Packet Data (CDPD) connection, digital satellite data connection, or the like. For example, the network interface 1109 may allow the computer to communicate with other computers via one or more local, wide-area, or other networks, as shown in FIG. 12.

Many other devices or components (not shown) may be connected in a similar manner (e.g., document scanners, digital cameras, and so on). Conversely, all the components shown in FIG. 11 need not be present to practice the present disclosure. The components can be interconnected in different ways from that shown. The operation of a computer such as that shown in FIG. 11 is readily known in the art and is not discussed in detail in this application. Code to implement the present disclosure can be stored in computer-readable storage media such as one or more of the memory 1107, fixed storage 1103, removable media 1105, or on a remote storage location.

FIG. 12 shows an example network 1200 arrangement according to an implementation of the disclosed subject matter. One or more clients 1210, 1220, such as local computers, phones, tablet computing devices, and the like may connect to other devices via one or more networks 1207. The network 1230 may be a local network, wide-area network, the Internet, or any other suitable communication network or networks, and may be implemented on any suitable platform including wired and/or wireless networks. The clients may communication with a remote processing unit 1240 which may be in further communication with a remote analysis system 1250. The clients may communicate with one or more servers 1260 and/or databases 1270. The devices may be directly accessible by the clients 1210, 1211, or one or more other devices may provide intermediary access via 1262 such as where a server 1260 provides access to resources stored in a database 1270. The clients 1210, 1211 also may access remote platforms 1280 or services provided by remote platforms 1280 such as cloud computing arrangements and services. The remote platform 1280 may include one or more remote servers 1282 and/or remote databases 1284.

More generally, various implementations of the presently disclosed subject matter may include or be implemented in the form of computer-implemented processes and apparatuses for practicing those processes. The disclosed subject matter also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, in which, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, in which when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions.

Implementations may use hardware that includes a processor, such as a general-purpose microprocessor and/or an Application Specific Integrated Circuit (ASIC) that embodies all or part of the techniques according to the methods of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to the methods of the disclosed subject matter.

The present disclosure provides various systems, techniques, and arrangements, including but not limited to the following: a computer-implemented method for evaluating a device design to reduce vibrational energy transfer between adjoining components of a device produced by an audio speaker component in the device, may include generating a configuration of a first device design, the configuration including corresponding specifications for a plurality of components including at least one audio speaker component and obtaining a computerized model of the first device design. The method may further include extracting a natural frequency and a mode shape of the computerized model of the first device design, and creating, based on the extracted natural frequency and mode shape, at least one analysis monitoring point in the computerized model between at least two adjacent components of the plurality of components defining a relative distance between the at least two adjacent components. The method may further include receiving simulation input scheme values simulating parameters influenced by the vibrational energy transferred by the at least one audio speaker component to the computerized model and determining a relative displacement of the at least two adjacent components at the at least one analysis monitoring point.

The method may further include generating a first risk assessment value based on the relative displacement of the at least one analysis monitoring point, determining that the first risk assessment value is greater than an optimum design threshold risk value, and responsive to determining that the first risk assessment value is greater than the threshold risk value, modifying the first device design to create a second device design by modifying at least one of a dimensional value or a material characteristic value of at least one element from the at least two adjacent components.

The method may further include solving, using a linear dynamics finite element analysis (FEA) solver and the simulation input scheme values, a system equation to obtain the relative displacement of the at least one analysis monitoring point.

The method may further include causing the device to be produced according to the second device design.

The method may further include the plurality of components including at least one selected from the group consisting of, a housing for the at least one audio speaker component, an enclosure for the first device, a display for the first device, a circuit board for the first device, a sensor for the first device, a power supply for the first device, a camera for the first device, a haptic feedback device for the first device, and an inertial measurement unit (IMU) for the first device.

The method may further include extracting the natural frequency and the mode shape of at least one of, at least one component of the plurality of components, and at least one constrained sub-set of components from the plurality of components.

The method may further include defining the at least one analysis monitoring point between at least two constrained sub-sets of adjacent components defining the relative distance between the at least two constrained sub-sets of adjacent components.

The method may further include causing the processor to solve, using the linear dynamics finite element analysis (FEA) solver, the system equations having the simulation input scheme values for the relative displacement of the at least two constrained sub-sets of adjacent components at the at least one analysis monitoring point.

The method may further include modifying the first device design by determining the first risk assessment value is greater than the optimum design threshold risk value, to create the second device design by modifying one of a dimensional value or a material characteristic value of at least one element from the at least two constrained sub-sets of adjacent components.

The method may further include the simulation input scheme values including at least one excitation frequency value to be simulated at the at least one audio speaker component in the computerized model, at least one of an assembly gap design value and a dimensional tolerance value at the at least one analysis monitoring point in the computerized model, and a system dampening value in the computerized model under influence of the at least one excitation frequency value.

The method may further include generating the first risk assessment value by comparing the relative displacement of the at least one analysis monitoring point with at least one of the assembly gap design value and the dimensional tolerance value at the at least one analysis monitoring point.

The method may further include generating a second risk assessment value by performing a statistical analysis of the relative displacement of the at least one analysis monitoring point through modal contribution and sensitivity analysis.

The method may further include determining if one of the first risk assessment value, the second risk assessment value or a sum of the first and second risk assessment values is greater than the optimum design threshold risk value.

The method may further include modifying the first device design based on the determining that one of the first, second or sum of first and second risk assessment values is greater than the optimum design threshold risk value, to create the second device design.

A computer-implemented method for evaluating a device design to reduce vibrational energy transfer between adjoining components of a device produced by an audio speaker component in the device may include generating a configuration of a first device design, the configuration including corresponding specifications for a plurality of components including at least one audio speaker component and at least one component. The component may be selected from the group consisting of, a housing for the at least one audio speaker component, an enclosure for the first device, a display for the first device, a circuit board for the first device, a sensor for the first device, a power supply for the first device, a camera for the first device, a haptic feedback device for the first device, and an inertial measurement unit (IMU) for the first device.

The method may further include obtaining a computerized model of the first device design, and extracting a natural frequency and a mode shape from the computerized model of at least one selected from the group consisting of the computerized model, at least one component of the plurality of components, and at least one constrained sub-set of components from the plurality of components.

The method may further includes creating, based on the extracted natural frequency and mode shape, at least one analysis monitoring point in the model between one of at least two adjacent components of the plurality of components, or at least two constrained sub-sets of adjacent components of the plurality of components, the at least one analysis monitoring point defining a relative distance between one of the at least two adjacent components, or the at least two constrained sub-sets of adjacent components.

The method may further include receiving simulation input scheme values including at least one excitation frequency value to be simulated at the at least one audio speaker component in the computerized model, at least one of an assembly gap design value and a dimensional tolerance value at the at least one analysis monitoring point in the computerized model, and a system dampening value for the computerized model under influence of the at least one excitation frequency value.

The method may further include determining a relative displacement of the at least one analysis monitoring point, and generating a first risk assessment value by comparing the relative displacement of the at least one analysis monitoring point with at least one of the assembly gap design value and the dimensional tolerance value at the at least one analysis monitoring point.

The method may further include generating a second risk assessment value and determining if one of the first risk assessment value, the second risk assessment value or a sum of the first and second risk assessment values is greater than an optimum design threshold risk value.

The method may further include, responsive to determining that one of the first, second or sum of first and second risk assessment values is greater than the optimum design threshold risk value, creating a second device design by modifying a value of at least one element from one of the at least two adjacent components or the at least two constrained sub-sets of adjacent components.

The method may further include determining the relative displacement of the two adjacent components by solving, using a linear dynamics finite element analysis (FEA) solver and the simulation input scheme values, system equations for the relative displacement of the at least one analysis monitoring point.

The method may further include the generation of the second risk assessment value by performing a statistical analysis of the relative displacement of the at least one analysis monitoring point through modal contribution and sensitivity analysis.

The method may further include causing the device to be produced according to the second device design.

The method may further include where the corresponding specifications for the plurality of components further include dimensional values and material values for each of the plurality of components.

The method may further include empirically obtaining the at least one excitation frequency value from data obtained by a laser vibrometer recording displacement value of the device corresponding to an excitation frequency value applied to the device.

The method may further include creating the second device design further by modifying a dimensional value of the at least one element from one of the at least two adjacent components or the at least two constrained sub-sets of adjacent components.

The method may further include creating the second device design by modifying a material characteristic value of the at least one element from one of the at least two adjacent components or the at least two constrained sub-sets of adjacent components.

The method may further include determining if the one of the first risk assessment value, the second risk assessment value or the sum of the first and second risk assessment values is greater than the optimum design threshold risk value further by determining if the solved relative displacement causes the relative distance to be equal to or less than a zero-relative distance value.

A means for evaluating a device design to reduce vibrational energy transfer between adjoining components of a device produced by an audio speaker component in the device, including a means for generating a configuration of a first device design, where the configuration includes corresponding specifications for a plurality of components including at least one audio speaker component and obtaining a computerized model of the first device design. The means for evaluating further includes extracting a natural frequency and a mode shape of the computerized model of the first device design, and creating, based on the extracted natural frequency and mode shape, at least one analysis monitoring point in the computerized model between at least two adjacent components of the plurality of components defining a relative distance between the at least two adjacent components. The means for evaluating further includes receiving simulation input scheme values simulating parameters influenced by the vibrational energy transferred by the at least one audio speaker component to the computerized model and determining a relative displacement of the at least two adjacent components at the at least one analysis monitoring point.

The means for evaluating further includes generating a first risk assessment value based on the relative displacement of the at least one analysis monitoring point, determining that the first risk assessment value is greater than an optimum design threshold risk value. The means for evaluating further includes modifying, responsive to the means for determining that the first risk assessment value is greater than the threshold risk value, the first device design to create a second device design by modifying at least one of a dimensional value or a material characteristic value of at least one element from the at least two adjacent components.

A system for evaluating a device design, wherein the system includes a memory configured to store processor instructions; and a processor in communication with the memory. The processor is configured to execute the processor instructions to perform: generating a configuration of a first device design, the configuration comprising corresponding specifications for a plurality of components including at least one audio speaker component; obtaining a computerized model of the first device design; extracting a natural frequency and a mode shape of the computerized model of the first device design; creating, based on the extracted natural frequency and mode shape, at least one analysis monitoring point in the computerized model between at least two adjacent components of the plurality of components defining a relative distance between the at least two adjacent components; receiving simulation input scheme values simulating parameters influenced by the vibrational energy transferred by the at least one audio speaker component to the computerized model; determining a relative displacement of the at least two adjacent components at the at least one analysis monitoring point; generating a first risk assessment value based on the relative displacement of the at least one analysis monitoring point; determining that the first risk assessment value is greater than an optimum design threshold risk value; and responsive to determining that the first risk assessment value is greater than the threshold risk value, modifying the first device design to create a second device design by modifying at least one of a dimensional value or a material characteristic value of at least one element from the at least two adjacent components.

A non-transitory computer-readable medium storing computer code for controlling a processor to cause the processor to perform a method, the computer code including instructions to cause the processor to: generate a configuration of a first device design, the configuration comprising corresponding specifications for a plurality of components including at least one audio speaker component; obtain a computerized model of the first device design; extract a natural frequency and a mode shape of the computerized model of the first device design; create, based on the extracted natural frequency and mode shape, at least one analysis monitoring point in the computerized model between at least two adjacent components of the plurality of components defining a relative distance between the at least two adjacent components; receive simulation input scheme values simulating parameters influenced by the vibrational energy transferred by the at least one audio speaker component to the computerized model; determine a relative displacement of the at least two adjacent components at the at least one analysis monitoring point; generate a first risk assessment value based on the relative displacement of the at least one analysis monitoring point; determine that the first risk assessment value is greater than an optimum design threshold risk value; and responsive to determining that the first risk assessment value is greater than the threshold risk value, modify the first device design to create a second device design by modifying at least one of a dimensional value or a material characteristic value of at least one element from the at least two adjacent components.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

What is claimed is:

1. A computer-implemented method for evaluating a device design, the method comprising:
generating a configuration of a first device design, the configuration comprising corresponding specifications for a plurality of components including at least one audio speaker component;
obtaining a computerized model of the first device design;
extracting a natural frequency and a mode shape of the computerized model of the first device design;
creating, based on the extracted natural frequency and mode shape, at least one analysis monitoring point in the computerized model between at least two adjacent components of the plurality of components defining a relative distance between the at least two adjacent components;
receiving simulation input scheme values simulating parameters influenced by vibrational energy transferred by the at least one audio speaker component to the computerized model;
determining a relative displacement of the at least two adjacent components at the at least one analysis monitoring point;
generating a first risk assessment value based on the relative displacement of the at least one analysis monitoring point;
determining that the first risk assessment value is greater than an optimum design threshold risk value; and
responsive to determining that the first risk assessment value is greater than the optimum design threshold risk value, modifying the first device design to create a second device design by modifying at least one of a dimensional value or a material characteristic value of at least one element from the at least two adjacent components.

2. The computer-implemented method of claim 1, wherein the step of determining the relative displacement of the two adjacent components further comprises solving, using a linear dynamics finite element analysis (FEA) solver and the simulation input scheme values, a system equation to obtain the relative displacement of the at least one analysis monitoring point.

3. The computer-implemented method of claim 1, wherein the plurality of components further comprises at least one selected from the group consisting of:
a housing for the at least one audio speaker component,
an enclosure for the first device,
a display for the first device,
a circuit board for the first device,
a sensor for the first device,
a power supply for the first device,
a camera for the first device,
a haptic feedback device for the first device, and
an inertial measurement unit (IMU) for the first device.

4. The computer-implemented method of claim 1, further comprising extracting the natural frequency and the mode shape of at least one of:
at least one component of the plurality of components; and
at least one constrained sub-set of components from the plurality of components.

5. The computer-implemented method of claim 4, wherein the at least one analysis monitoring point is further defined between at least two constrained sub-sets of adjacent components defining the relative distance between the at least two constrained sub-sets of adjacent components.

6. The computer-implemented method of claim 5, further configured to cause the processor to solve, using the linear dynamics finite element analysis (FEA) solver, the system equations having the simulation input scheme values for the relative displacement of the at least two constrained sub-sets of adjacent components at the at least one analysis monitoring point.

7. The computer-implemented method of claim 6, further comprising:
modifying the first device design based on the determining the first risk assessment value is greater than the optimum design threshold risk value, to create the second device design by modifying one of a dimensional value or a material characteristic value of at least one element from the at least two constrained sub-sets of adjacent components.

8. The computer-implemented method of claim 1, wherein the simulation input scheme values further comprise:
at least one excitation frequency value to be simulated at the at least one audio speaker component in the computerized model;
at least one of an assembly gap design value and a dimensional tolerance value at the at least one analysis monitoring point in the computerized model; and
a system dampening value in the computerized model under influence of the at least one excitation frequency value.

9. The computer-implemented method of claim 8, wherein generating the first risk assessment value further comprises:
comparing the relative displacement of the at least one analysis monitoring point with at least one of the assembly gap design value and the dimensional tolerance value at the at least one analysis monitoring point.

10. The computer-implemented method of claim 9, wherein the computer instructions are further configured to cause the processor to generate a second risk assessment value by performing a statistical analysis of the relative displacement of the at least one analysis monitoring point through modal contribution and sensitivity analysis.

11. The computer-implemented method of claim 10, further comprising:
determining if one of the first risk assessment value, the second risk assessment value or a sum of the first and second risk assessment values is greater than the optimum design threshold risk value.

12. The computer-implemented method of claim 9, wherein modifying the first device design is further based on the determining that one of the first, second or sum of first and second risk assessment values is greater than the optimum design threshold risk value, to create the second device design.

13. A system for evaluating a device design, wherein the system comprises:
a memory configured to store processor instructions; and
a processor in communication with the memory, the processor configured to execute the processor instructions to perform:
generating a configuration of a first device design, the configuration comprising corresponding specifications for a plurality of components including at least one audio speaker component;
obtaining a computerized model of the first device design;
extracting a natural frequency and a mode shape of the computerized model of the first device design;
creating, based on the extracted natural frequency and mode shape, at least one analysis monitoring point in the computerized model between at least two adjacent components of the plurality of components defining a relative distance between the at least two adjacent components;
receiving simulation input scheme values simulating parameters influenced by vibrational energy transferred by the at least one audio speaker component to the computerized model;
determining a relative displacement of the at least two adjacent components at the at least one analysis monitoring point;
generating a first risk assessment value based on the relative displacement of the at least one analysis monitoring point;
determining that the first risk assessment value is greater than an optimum design threshold risk value; and
responsive to determining that the first risk assessment value is greater than the optimum design threshold risk value, modifying the first device design to create a second device design by modifying at least one of a dimensional value or a material characteristic value of at least one element from the at least two adjacent components.

14. The computer-implemented method of claim 13, wherein the step of determining the relative displacement of the two adjacent components further comprises solving, using a linear dynamics finite element analysis (FEA) solver and the simulation input scheme values, system equations for the relative displacement of the at least one analysis monitoring point.

15. The computer-implemented method of claim 13, wherein the processor is configured to further perform:
generating a second risk assessment value;
determining if one of the first risk assessment value, the second risk assessment value or a sum of the first and second risk assessment values is greater than the optimum design threshold risk value; and
responsive to determining that one of the first, second or sum of first and second risk assessment values is greater than the optimum design threshold risk value, create the second device design by modifying a value of the at least one element from one of the at least two adjacent components.

16. The computer-implemented method of claim 13, wherein the corresponding specifications for the plurality of components further comprise dimensional values and material characteristic values for each of the plurality of components.

17. The computer-implemented method of claim 13, wherein the processor is configured to further perform:
empirically obtaining the simulation input scheme values from data obtained by a laser vibrometer recording displacement values of the first device design corresponding to an excitation frequency value applied to the first device design.

18. The computer-implemented method of claim 13, wherein creating the second device design further modifies a dimensional value of at least two constrained sub-sets of adjacent components of the plurality of components.

19. The computer-implemented method of claim 13, wherein creating the second device design further modifies material characteristic values of at least two constrained sub-sets of adjacent components of the plurality of components.

20. A non-transitory computer-readable medium storing computer code for controlling a processor to cause the processor to perform a method, the computer code including instructions to cause the processor to:
generate a configuration of a first device design, the configuration comprising corresponding specifications for a plurality of components including at least one audio speaker component;
obtain a computerized model of the first device design;
extract a natural frequency and a mode shape of the computerized model of the first device design;
create, based on the extracted natural frequency and mode shape, at least one analysis monitoring point in the computerized model between at least two adjacent components of the plurality of components defining a relative distance between the at least two adjacent components;
receive simulation input scheme values simulating parameters influenced by vibrational energy transferred by the at least one audio speaker component to the computerized model;
determine a relative displacement of the at least two adjacent components at the at least one analysis monitoring point;
generate a first risk assessment value based on the relative displacement of the at least one analysis monitoring point;
determine that the first risk assessment value is greater than an optimum design threshold risk value; and
responsive to determining that the first risk assessment value is greater than the optimum design threshold risk value, modify the first device design to create a second device design by modifying at least one of a dimensional value or a material characteristic value of at least one element from the at least two adjacent components.
